(19) United States
(12) Patent Application Publication
(10) Pub. No.: US 2026/0194956 A1
(43) Pub. Date: Jul. 9, 2026

(54) DYNAMIC POWER OPTIMIZATION FOR HIGH-SPEED INTERCONNECTS USING MACHINE LEARNING

(71) Applicant: NVIDIA Corporation, Santa Clara, CA (US)

(72) Inventors: Aniket Dilip NAIK, San Jose, CA (US); Marc Andrew FELIX, San Jose, CA (US); Xutong LI, San Jose, CA (US); Chad PLUMMER, Fairfax, CA (US); Aditya CHAUDHRY, San Francisco, CA (US); Milica DESPOTOVIC, San Jose, CA (US); Angel CARVAJAL, Bronx, NY (US); Chaitanya PAIKARA, San Jose, CA (US); Arvind GOPALAKRISHNAN, Fremont, CA (US)

(73) Assignee: NVIDIA Corporation, Santa Clara, CA (US)

(21) Appl. No.: 19/011,203

(22) Filed: Jan. 6, 2025

(51) Int. Cl. G06F 1/3212

(52) U.S. Cl. CPC G06F 1/3212

(57) ABSTRACT

In various examples, a system can include one or more processors to determine a plurality of first telemetry values from a graphics processing unit (GPU) and a plurality of second telemetry values from a central processing unit (CPU), the plurality of first telemetry values and the plurality of second telemetry values indicative of a workload of a computing device, determine, based at least on the plurality of first telemetry values and the plurality of second telemetry values, a power expenditure value of a high-speed interface coupled to the GPU and the CPU by selecting, using a neural network, a speed for the high-speed interface, and communicate, by the high-speed interface, data using the speed.

### BACKGROUND

High-speed interconnects can transfer data between two components within a system and handle large volumes of data. High-speed interconnects can also have various power configurations or operations modes that can be utilized in certain usage scenarios to reduce an active power consumption of the high-speed interconnect while maintaining performance requirements. Conventional techniques to adjust the power configurations of the high-speed interconnects may require user input, such as manual tuning or coding.

### SUMMARY

Implementations of the present disclosure relate to dynamic power optimization for high-speed interconnects using machine learning. Systems and methods are disclosed that allow for automatic execution of optimal power configurations for the high-speed interconnects. The system can determine telemetry values on both sides or endpoints of the high-speed interconnect and use a neural network to determine an optimal power configuration based on the telemetry values. Following determination of the optimal power configuration, the system can execute the optimal configuration on the high-speed interconnect.

In contrast to conventional systems, such as those described above, the system of the present disclosure can include one or more processors to determine a plurality of first telemetry values from a graphics processing unit (GPU) and a plurality of second telemetry values from a central processing unit (CPU), the plurality of first telemetry values and the plurality of second telemetry values indicative of a workload of a computing device, determine, based at least on the plurality of first telemetry values and the plurality of second telemetry values, a power expenditure value of a high-speed interface coupled to the GPU and the CPU by selecting, using a neural network, a speed for the high-speed interface, and communicate, by the high-speed interface, data using the speed.

In various implementations, the one or more processors receives a mode of the computing device, determine a power value, the power value indicative of a difference between the power expenditure value prior to and following communication of data using the speed on the high-speed interface, and allocate the power value to one or more components of the computing device based on the mode. The mode can include a battery mode or a core mode, the battery mode indicative of allocating the power value to a battery to prolong a life of the computing device and the core mode indicative of allocating the power value to a core to improve a performance of the computing device. To determine the speed, the one or more processors can determine, by the neural network, a plurality of execution times and a plurality of performance values for a plurality of speeds of the high-speed interface, the plurality of execution times indicative of a data transfer rate of the high-speed interface and the plurality of performance values indicative of a performance of the high-speed interface and select, by the neural network, the speed from the plurality of speeds based on the plurality of execution times and the plurality of performance values.

In various implementations, the high-speed interface includes a peripheral component interconnect express (PCIe). The neural network can be updated on a training dataset to select the speed prior to execution on the computing device, the training dataset comprising a plurality of training telemetry values corresponding to a plurality of training execution times and a plurality of training performance values. The plurality of first telemetry values and the plurality of second telemetry values can include operating frequency, utilization, analog measurements, performance monitor counters, activity status, current operation status, and current low power mode status of at least one of the GPU, the CPU, or the high-speed interface.

In various implementations, the one or more processors are included in at least one of a control system for an autonomous or semi-autonomous machine, a perception system for an autonomous or semi-autonomous machine, a system implemented using a robot, an aerial system, a medical system, a boating system, a smart area monitoring system, a system for performing deep learning operations, a system for performing simulation operations, a system for generating or presenting virtual reality (VR) content, augmented reality (AR) content, or mixed reality (MR) content, a system for performing digital twin operations, a system implemented using an edge device, a system incorporating one or more virtual machines (VMs), a system for generating synthetic data, a system implemented at least partially in a data center, a system for performing conversational artificial intelligence (AI) operations, a system for performing generative AI operations, a system implementing language models, a system implementing vision language models (VLMs), a system implementing large language models (LLMs), a system implementing small language models (SLMs), a system implementing multi-modal language models, a system for hosting one or more real-time streaming applications, a system for performing light transport simulation, a system for performing collaborative content creation for 3D assets, or a system implemented at least partially using cloud computing resources.

At least one aspect of the present disclosure is directed to a system including one or more processors to determine a plurality of first telemetry values from a first processing unit and a plurality of second telemetry values from a second processing unit, the plurality of first telemetry values and the plurality of second telemetry values indicative of a workload of a computing device, determine, using a neural network, a parameter value for a parameter of a communication interface coupled to the first processing unit and the second processing unit based at least on the plurality of first telemetry values and the plurality of second telemetry values, the parameter value indicative of a bandwidth of the communication interface, and configure the communication interface using the parameter value.

In various implementations, the parameter is at least one of a link bandwidth capacity, power state entry threshold, operating frequency, power mode, power cap, latency tolerance, or credit throttling of the communication interface. The plurality of first telemetry values and the plurality of second telemetry values can include at least one of operating frequency, utilization, analog measurements, performance monitor counters, activity status, current operation status, and current low power mode status of at least one of the first processing unit, the second processing unit, or the communication interface. The one or more processors can also receive a mode of the computing device, determine a power value, the power value indicative of a difference between a bandwidth value prior to and following communication of data using the parameter value on the communication interface, and allocate the power value to one or more components of the computing device based on the mode. The mode can include a battery mode or a core mode, the battery mode indicative of allocating the power value to a battery to prolong a life of the computing device and the core mode indicative of allocating the power value to a core to improve a performance of the computing device.

In various implementations, to determine the parameter value, the one or more processors determine, by the neural network, a plurality of execution times and a plurality of performance values for a plurality of parameter values of the communication interface, the plurality of execution times indicative of a data transfer rate of the communication interface and the plurality of performance values indicative of a performance of the communication interface and select, by the neural network, the parameter value from the plurality of parameter values based on the plurality of execution times and the plurality of performance values. The first processing unit can be a graphics processing unit (GPU) and the second processing unit can be a central processing unit (CPU).

In various implementations, the neural network is updated on a training dataset to select the parameter value prior to execution on the computing device, the training dataset comprising a plurality of training telemetry values corresponding to a plurality of training execution times and a plurality of training performance values. The neural network can be executed on a hardware co-processors. The communication interface can include a high speed communication interface.

At least one aspect of the present disclosure is directed to a method including determining a plurality of first telemetry values from a first processing unit and a plurality of second telemetry values from a second processing unit, the plurality of first telemetry values and the plurality of second telemetry values indicative of a workload of a computing device, determining, by a neural network, a plurality of execution times and a plurality of performance values for a plurality of parameter values of a communication interface coupled to the first processing unit and the second processing unit, the plurality of parameter values indicative of a bandwidth of the communication interface, the plurality of execution times indicative of a data transfer rate of the communication interface, and the plurality of performance values indicative of a performance of the communication interface, selecting a parameter value from the plurality of parameter values based on the plurality of execution times and the plurality of performance values, and operating the communication interface at the parameter value.

In various implementations, the neural network is updated on a training dataset to select the parameter value prior to execution on the computing device, the training dataset comprising a plurality of training telemetry values corresponding to a plurality of training execution times and a plurality of training performance values.

### BRIEF DESCRIPTION OF THE DRAWINGS

The present systems and methods for power optimization for high-speed interconnects using machine learning are described in detail below with reference to the attached drawing figures, wherein:

FIG. 1 is a block diagram of an example of a system for selecting an interface parameter value, in accordance with some implementations of the present disclosure;

FIG. 2 is a block diagram of an example of a system for updating an interface parameter value selection model, in accordance with some implementations of the present disclosure;

FIG. 3 is a block diagram of an example of a system for selecting an interface parameter value and determining a power value, in accordance with some implementations of the present disclosure;

FIG. 4 is a flow diagram of an example method for selecting a speed and communicating data using the speed, in accordance with some implementations of the present disclosure;

FIG. 5 is a flow diagram of an example method for selecting a parameter value and communicating data using the parameter value, in accordance with some implementations of the present disclosure;

FIG. 6 is a flow diagram of an example method for selecting a parameter value and communicating data using the parameter value, in accordance with some implementations of the present disclosure;

FIG. 7 is a block diagram of an example computing device suitable for use in implementing some implementations of the present disclosure; and

FIG. 8 is a block diagram of an example data center suitable for use in implementing some implementations of the present disclosure.

### DETAILED DESCRIPTION

Systems and methods are disclosed related to power optimization for high-speed interconnects using machine learning. As non-limiting examples, a neural network can be updated using performance, power, and telemetry values from various processing units of a computing device, such as a graphics processing unit (GPU) and a central processing unit (CPU). The neural network may be updated prior to execution on a computing device and may be implemented to determine and adjust the high-speed interconnects of the computing device based on an optimal power configuration. Power saved by the neural network may be reallocated to either a battery of the computing device for longer battery life or to a core for higher performance of the computing device.

This disclosure relates to systems and methods for optimizing power and performance for high-speed interconnects (e.g., PCIe), such as to enable saving power via PCIe interfaces while also maintaining performance. Power saved from various high-speed interconnects (e.g., non-volatile memory express (NVMe)) can be used to improve battery life (e.g., of devices) or be transferred to boost performance of the core. One method to do this includes adjusting a generation (e.g., gen) speed of the high-speed interconnects. However, various applications (e.g., on a device) have varying performance requirements and may respond differently to gen speed adjustments. Such applications may have varying high-speed interconnect throughput bounds, and each application may have different optimal gen speeds. Further, while it is possible for an end user to manually select an optimal gen speed, end users may be required to tune the gen speed per application and use case.

Systems and methods in accordance with the present disclosure can implement a neural network to dynamically determine an optimal high-speed interconnect gen speed based on telemetry (e.g., various data and metrics related to performance, health, and usage of a device) received from, for example, the GPU, the CPU, the high-seed interconnect, and/or other such sources. The telemetry may be received by a unit activity counter random access memory (RAM) to determine a workload (e.g., tasks) of the device. The neural network may be executed by a hardware co-processor and a controller within a power management unit to control and operate the high-speed interconnect at a gen speed determined by the neural network. The neural network may generate a compilation (e.g., in a table, etc.) of relative execution time to gen speeds of the high-speed interconnect to determine an optimal gen speed for the current telemetry. For example, the neural network may select the optimal gen speed based on a combination of a lower relative execution time (e.g., compared to other gen speeds) and a higher performance value (e.g., compared to other gen speeds). The hardware co-processor may be installed on a chip and be dedicated to executing the neural network and determining the optimal gen speed. For example, the system may receive telemetry from the GPU and input the telemetry into the neural network. The neural network may then determine an optimal gen speed for the high-speed interconnect based on the telemetry and communicate the optimal gen speed to the controller. The controller may then set the high-speed interconnect to run at the optimal gen speed.

Power saved from running the high-speed interconnects at the optimal gen speed may be redirected based on a mode of the system. The modes may include a direct current (DC) mode and an alternating current (AC) mode. For example, responsive to the system being set to the DC mode, the power saved may be redirected towards a battery connected to the chip (e.g., computer battery) to prolong battery life. As another example, responsive to the system being set to the AC mode, the power saved may be directed towards a core (e.g., of the GPU) to improve performance.

The neural network may be updated (e.g., trained) offline via supervised learning of various workloads associated with different gen speeds. The training may take place during chip bring up (e.g., testing the chip). The various workloads may include telemetry from the various processing units (e.g., CPU, GPU, etc.), and may be an overall performance metric. The training may enable the neural network to learn a relationship between the various workloads and different gen speeds.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed implementations may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

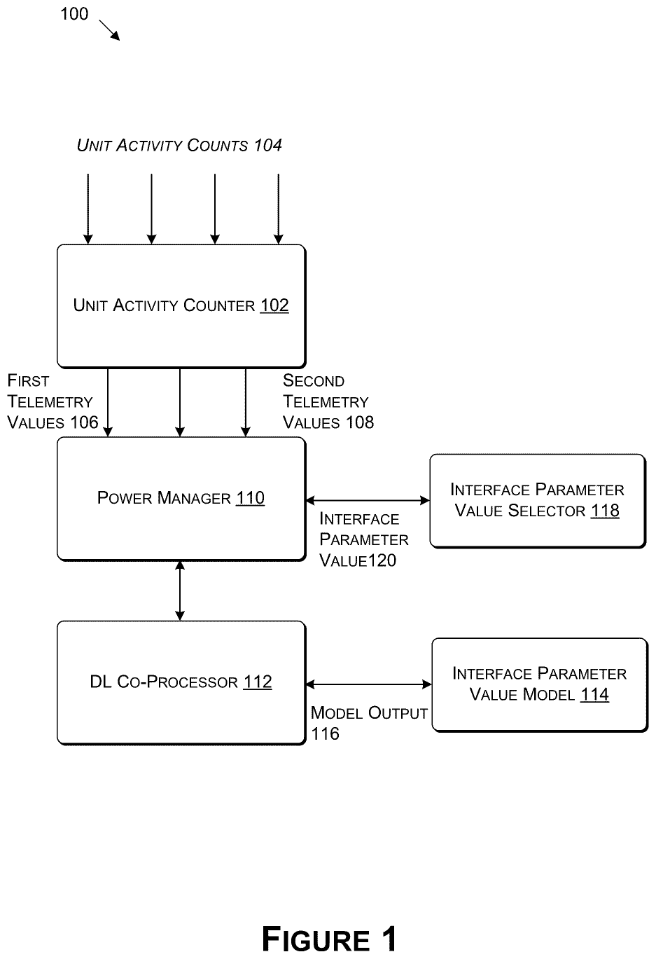

With reference to FIG. 1, FIG. 1 is an example system 100 for selecting an interface parameter value, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 can include one or more unit activity counters 102. The unit activity counter 102 can be hardware and/or firmware. The unit activity counter 102 can be a random access memory (RAM). The unit activity counter 102 can be coupled to a plurality of processing units (e.g., a first processing unit, a second processing unit, etc.) and a communication interface (e.g., communication interface 710). One end of the communication interface can be coupled to the first processing unit while another end of the communication interface is coupled to the second processing unit. For example, the first processing unit can be a graphics processing unit (GPU) (e.g., GPU 708), and the second processing unit can be a central processing unit (CPU) (e.g., CPU 706). The communication interface can be a high-speed interface. The high-speed interface can include, but not limited to, at least one of a peripheral component interconnect express (PCIe), a non-volatile memory express (NVMe), a serial advanced technology attachment (SATA), a U.2, a hypertransport (HT), a crossbar switch, a NVLink, or a compute express link (CXL).

The unit activity counter 102 can receive unit activity counts 104 from the first processing unit, the second processing unit, the communication interface, or a combination thereof. The unit activity counter 102 can count or otherwise track various metrics, such as cache reads, multiplications, or additions indicative of a workload (e.g., operations and processes being executed) of the computing device. The unit activity counter 102 can store the unit activity counts 104. The unit activity counts 104 can include at least a plurality of first telemetry values 106 from the first processing unit and a plurality of second telemetry values 108 from the second processing unit. The unit activity counter 102 can also receive the plurality of first telemetry values 106 and the plurality of second telemetry values 108 from the communication interface. For example, the unit activity counter 102 can receive the plurality of first telemetry values 106 from a first side of the communication interface coupled to the first processing unit and the plurality of second telemetry values 108 from a second side of the communication interface coupled to the second processing unit. The unit activity counter 102 can receive various telemetry values (e.g., the plurality of first telemetry values 106, the plurality of second telemetry values 108, etc.) from at least one of the first processing unit, the second processing unit, and the communication interface. The unit activity counter 102 can also store the various telemetry values. The plurality of first telemetry values 106 and the plurality of second telemetry values 108 can be indicative of the workload of a computing device (e.g., computing device 700).

The various telemetry values can include, but not limited to, utilization of at least one of the first processing unit or the second processing unit, a clock speed (e.g., frequency of operations) of at least one of the first processing unit or the second processing unit, a rate of instruction execution by at least one of the first processing unit or the second processing unit, a bus arbitration (BA) signal, and performance readings of at least one of the first processing unit or the second processing unit. In some implementations, the various telemetry values can also include, but not limited to, operating temperature, power consumption, cache usage, load average (e.g., measure of utilization and workload demand), core voltage, memory clock speed, memory usage, fan speed, frame rate (FPS), thermal throttling (e.g., changing clock speed to mitigate thermal damage), link speed, link width, throughput, latency (e.g., delay in data transmission), and error counts (e.g., number of errors occurred during data transfer) of at least one of the first processing unit, the second processing unit, or the communication interface. The various telemetry values can also include an operating frequency (e.g., clock speed), analog measurements (e.g., voltage, power), performance monitor counters, activity status (e.g., throughout measurement, link utilization), operation status (e.g., bandwidth capacity), and low power mode status (e.g., low power feature on or off) of at least one of the first processing unit, the second processing unit, or the communication interface. For example, the CPU can include a performance monitoring unit (PMU) to provide performance event counters and the GPU can include a block activity counter to count activities (e.g., tasks) of the GPU. The PCIe can also include a counter to measure, for example, data throughput of the PCIe.

The system 100 can include one or more power managers 110. The power manager 110 can be hardware and/or firmware. The power manager 110 can be coupled to the unit activity counter 102 and receive the various telemetry values (e.g., plurality of first telemetry values 106, the plurality of second telemetry values 108, etc.) from the unit activity counter 102. The power manager 110 can be a processor. The power manager 110 can preprocess (e.g., clean, process, augment) at least the plurality of first telemetry values 106 and the plurality of second telemetry values 108. For example, the power manager 110 can scale (e.g., normalize) the plurality of first telemetry values 106 and the plurality of second telemetry values 108. The power manager 110 can normalize the plurality of first telemetry values 106 and the plurality of second telemetry values 108 to be in a numerical range. For example, the numerical range can be between 0 and 1, inclusive. The power manager 110 can also calculate the plurality of first telemetry values 106 and the plurality of second telemetry values 108 as rates (e.g., values divided by time). This can account for variations in measurement windows of the plurality of first telemetry values 106 and the plurality of second telemetry values 108.

The system 100 can include one or more deep learning (DL) co-processors 112. The DL co-processor 112 can be hardware and/or firmware. The DL co-processor 112 can be coupled to the power manager 110 and receive the preprocessed telemetry values (e.g., preprocessed plurality of first telemetry values 106 and plurality of second telemetry values 108) from the power manager 110. In some implementations, the DL co-processor 112 is a hardware processor.

The DL co-processor 112 can include an interface parameter value model 114 running on the DL co-processor 112. The interface parameter value model 114 can be a neural network updated (e.g., trained) on a plurality of training telemetry values indicative of various workloads (e.g., lower and higher workloads) of the computing device. The interface parameter value model 114 can be trained via supervised learning where the plurality of training telemetry values is associated with a plurality of training execution times and a plurality of training performance values. The plurality of training execution times and the plurality of training performance values can each be associated with a parameter value of a parameter of the communication interface. The plurality of training execution times can be a duration it takes for the communication interface to execute a task (e.g., data transfer rate) while the plurality of training performance values can be indicative of a performance of the communication interface. The plurality of training performance values may be generated based on various metrics, such as but not limited to CPU performance compared to benchmark scores, graphics performance compared to benchmark scores, or power consumption. The parameter value can be indicative of a bandwidth of the communication interface. The parameter of the communication interface can be indicative of a bandwidth of the communication interface and can include, but not limited to, a speed, a credit, an allowance, a latency allowance, a link width, or a clock speed of the communication interface. For example, the parameter values for speed can include a gen speed of 1, 2, 3, 4, and 5 of the communication interface. As another example, the parameter value for link widths can include 16, 8, 4, 2, and 1 of the communication interface. In some implementations, the parameter of the communication interface can include, but not limited to, link bandwidth capacity (e.g., speed, gen speed, link width, number of enabled links, etc.), power state entry threshold (e.g., threshold to transition from active to lower power state), operating frequency (e.g., using dynamic voltage and frequency scaling (DVFS) to change operating frequency and/or voltage), power mode (e.g., state), power cap (e.g., maximum power usage), latency tolerance (e.g., maximum tolerance), or credit throttling (e.g., credit allocation, throttling threshold) of the communication interface.

The parameter value of the communication interface can be adjusted to optimize power and performance of the communication interface based on the workload. For example, varying the parameter value of the communication interface depending on the workload may have a better power and performance than a communication interface with a constant parameter value. For example, responsive to the workload being lower (e.g., requiring less bandwidth), a lower parameter value (e.g., lower gen speed) may save power and maintain performance. The interface parameter value model 114 can be trained to select a parameter value based on the plurality of training telemetry values (e.g., indicative of the workload), as described further herein.

The power manager 110 can program or otherwise provide to the DL co-processor 112 with telemetry values (e.g., the plurality of first telemetry values 106, the plurality of second telemetry values 108, etc.) to be fed into the interface parameter value model 114. The power manager 110, in some embodiments, can preprocess the plurality of first telemetry values 106 and the plurality of second telemetry values 108 based on bounds (e.g., minimum and maximum values in training data) of the interface parameter value model 114. For example, each of the telemetry values of the plurality of first telemetry values 106 and the plurality of second telemetry values 108 can be divided by a maximum value of the training data. This can normalize the plurality of first telemetry values 106 and the plurality of second telemetry values 108 to the training data.

The DL co-processor 112 can include a RAM programmed with, but not limited to, a network architecture, weights, and biases of the interface parameter value model 114. The power manager 110 can program the DL co-processor 112 with the plurality of first telemetry values 106 and the plurality of second telemetry values 108 to generate a calculation via the interface parameter value model 114. The interface parameter value model 114 can generate a model output 116 based at least on the plurality of first telemetry values 106 and the plurality of second telemetry values 108. The model output 116 can include a plurality of execution times and a plurality of performance values. The plurality of execution times can be a duration it takes for the communication interface to execute a task (e.g., data transfer rate) while the plurality of performance values can be indicative of a performance of the communication interface and/or the computing device. The plurality of performance values may be generated based on various metrics, such as but not limited to CPU performance compared to benchmark scores, graphics performance compared to benchmark scores, or power consumption. The interface parameter value model 114 can predict the plurality of execution times and the plurality of performance values of the computing device based at least on the plurality of first telemetry values 106 and the plurality of second telemetry values 108 per parameter value (e.g., per gen speed).

The plurality of execution times and the plurality of performance values can be associated with a plurality of parameter values. The plurality of execution times and the plurality of performance values can be predictions of an impact of implementing the plurality of parameter values on the communication interface and/or the computing device. The interface parameter value model 114 can receive the plurality of first telemetry values 106 and the plurality of second telemetry values 108 as an input, apply the different parameter values to the plurality of first telemetry values 106 and the plurality of second telemetry values 108, and generate the model output 116 as a result. For example, the interface parameter value model 114 may generate the model output 116 for a speed (e.g., gen speed) of the communication interface which can include five different speeds (e.g., the plurality of parameter values). The interface parameter value model 114 can apply each of the five speeds to the plurality of first telemetry values 106 and the plurality of second telemetry values 108 to generate the model output 116. The model output 116 can be a table and/or another data structure.

Once the interface parameter value model 114 generates the model output 116, the DL co-processor 112 can receive the model output 116 and provide the model output 116 to the power manager 110. The power manager 110 can include an interface parameter value selector 118. The interface parameter value selector 118 can be an algorithm (e.g., logic) for selecting an interface parameter value 120 for the communications interface from the model output 116. The interface parameter value selector 118 can be a controller. For example, the interface parameter value selector 118 can receive the plurality of execution times and the plurality of performance values of the model output 116 and select the interface parameter value 120 based on the plurality of execution times and plurality of performance values. The interface parameter value selector 118 may select the interface parameter value 120 based on the parameter value corresponding to a lowest execution time and highest performance value. For example, the interface parameter value selector 118 may select the interface parameter value 120 with an optimal combination of low execution times and high performance values. The interface parameter value selector 118 may apply a function (e.g., optimization function) to select the interface parameter value 120.

Following selection of the interface parameter value 120, the power manager 110 can set the communication interface to the interface parameter value 120. The power manager 110 can be coupled to the communication interface. The power manager 110 can adjust settings and/or parameter values of the communication interface. For example, responsive to the interface parameter value selector 118 selecting a gen speed for the communication interface, the power manager 110 can set the communication interface to operate at the gen speed. The communication interface can then communicate data using the interface parameter value 120.

Based off the interface parameter value 120, the power manager 110 can determine a power value of the computing device. The power value can be indicative of a difference between a power expenditure value (e.g., power consumption, power usage, etc.) of the computing device prior to and following the communication interface communicating data using the interface parameter value 120. The power value can be an amount of power saved by the communication interface by communicating data using the interface parameter value 120. For example, the power expenditure value prior to the communication interface communicating data using the interface parameter value 120 may be higher than the power expenditure value following the communication interface communicating data using the interface parameter value 120. The power manager 110 can determine the power expenditure value prior to the interface parameter value 120 being selected and after setting the communication interface to the interface parameter value 120. In some implementations, the power manager 110 can include a power expenditure threshold. Responsive to a power expenditure value of the computing device being at or above the power expenditure threshold, the interface parameter value model 114 may generate the model output 116.

Based on a mode of the computing device, the power manager 110 can allocate the power value to various components of the computing device as described further herein. For example, the computing device can include at least one of a battery mode or a core mode. Responsive to the computing device being set to the battery mode (e.g., by a user, entity, etc.), the power manager 110 can allocate the power value to a battery of the computing device to prolong a life of the computing device. Responsive to the computing device being set to the core mode, the power manager 110 can allocate the power value to a core (e.g., CPU) of the computing device to improve a performance (e.g., speed, throughput, etc.) of the computing device.

In some implementations, the interface parameter value model 114 and the interface parameter value selector 118 are combined. For example, both generating the model output 116 and selecting the interface parameter value 120 can be performed by the interface parameter value model 114. In this case, the interface parameter value model 114 can communicate the interface parameter value 120 to the power manager 110.

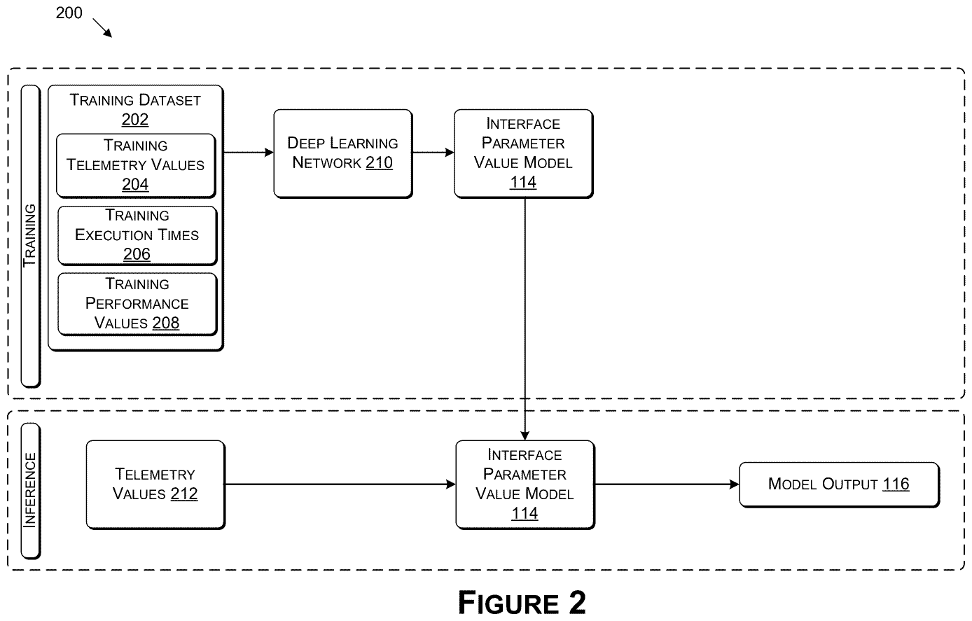

FIG. 2 is a block diagram of a system 200 for training the interface parameter value model 114 that can be used by the system of FIG. 1, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The interface parameter value model 114 can be updated (e.g., trained) offline during a training stage of the system 200. For example, the interface parameter value model 114 can be trained prior to execution (e.g., implementation) on the computing device. The interface parameter value model 114 can be trained during chip bring up (e.g., testing and validating of a chip before installation on the computing device). The interface parameter value model 114 can be trained on a training dataset 202. The training dataset 202 can be collected by running different workloads of the computing device at various frequencies (e.g., time between increasing or decreasing workloads) and parameter values of the communication interface. For example, the chip can be run through different computing workloads at different frequencies and different gen speeds of the communication interface to collect the training dataset 202. The training dataset 202 can include a plurality of training telemetry values 204, a plurality of training execution times 206, and a plurality of training performance values 208. The plurality of training telemetry values 204 can be collected from various components (e.g., the first processing unit, the second processing unit, communication interface, etc.) of the computing device as different workloads are being run. As the different workloads are being run, the parameter value can be changed to collect the plurality of training execution times 206 and the plurality of training performance values 208. For example, running a higher workload with a lower gen speed (e.g., gen speed 1) may have a lower performance value and lower execution time.

Each of the parameter values of the communication interface can correspond to a workload (e.g., the training telemetry values 204). The training telemetry values 204 and the parameter value can correspond to at least one of the training execution times 206 or the training performance values 208. The power manager 110 can use a maximum value of the training telemetry values 204 to normalize (e.g., scale) the plurality of first telemetry values 106 and the plurality of second telemetry values 108.

The system 200 can include one or more deep learning networks 210. The deep learning networks 210 can be updated (e.g., trained) on the training dataset 202. The deep learning network 210 can be trained via supervised training on the training dataset 202. The training telemetry values 204 can include telemetry values from both the first processing unit (e.g., GPU) and the second processing unit (e.g., CPU). The training telemetry values 204 can also include telemetry values from the communication interface (e.g., PCIe). The training telemetry values 204 can include, for example, performance metrics and a frame rate of the first processing unit, the second processing unit, and the communication interface. The training dataset 202 can include a ground truth (e.g., baseline) to train the deep learning network 210. The ground truth can be the training execution times 206 and the training performance values 208 associated with the training telemetry values 204. The ground truth can include the training execution times 206 and the training performance values 208 for each parameter value of the communication interface (e.g., gen speed 1, 2, 3, 4, and 5).

Following training, the deep learning network 210 can output the interface parameter value model 114. The interface parameter value model 114 can be a neural network. The interface parameter value model 114 can be updated (e.g., trained) to receive telemetry values and generate predictions of the execution times and performance values for various parameter values. For example, an input of the interface parameter value model 114 can be a plurality of parameter values of the communication interface and a plurality of telemetry values of the computing device. The interface parameter value model 114 can then output a plurality of execution times and performance values for each of the plurality of parameter values. As another example, the interface parameter value model 114 can generate predictions of execution times and performance values for each gen speed based on the telemetry values.

The system 200 can include telemetry values 212. The telemetry values 212 can be live (e.g., in real-time) telemetry values received from the first processing unit, the second processing unit, and/or the communication interface. The telemetry values 212 can include the plurality of first telemetry values 106, the plurality of second telemetry values 108, and/or a the plurality of telemetry values of the communication interface. During an inference (e.g., prediction) stage of the system 200, the interface parameter value model 114 can receive the telemetry values 212 and generate the model output 116. The model output 116 can include the plurality of execution times and the plurality of performance values for each of the plurality of parameter values. The interface parameter value model 114 can generate the model output 116 by predicting the plurality of execution times and the plurality of performance values for each of the parameter values based on the telemetry values 212.

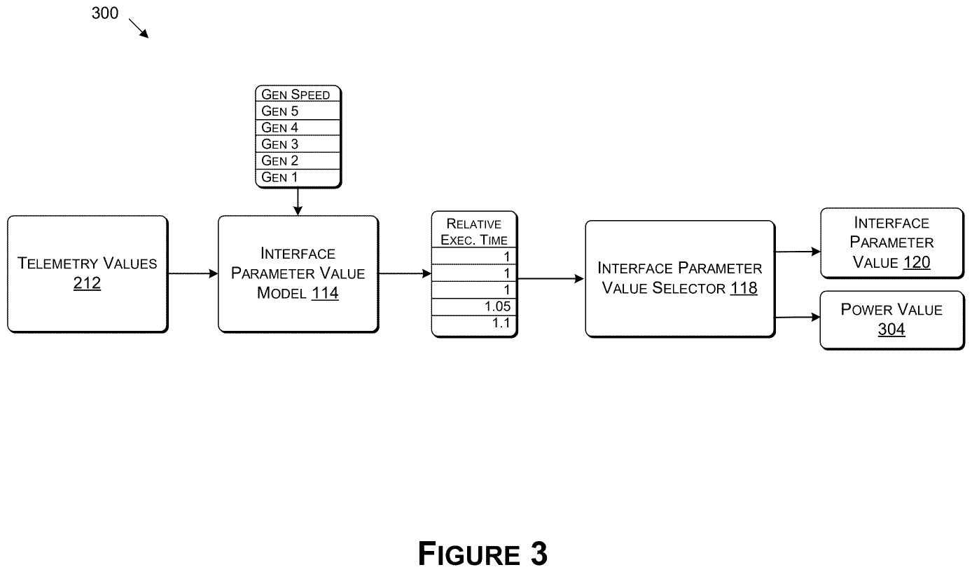

FIG. 3 is a block diagram of a system 300 for selecting a gen speed (e.g., interface parameter value 120) and determining a power value 304. The system 300 can be used by the system of FIG. 1 and/or FIG. 2, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As depicted in FIG. 3, the interface parameter value model 114 can receive the telemetry values 212 and generate relative execution times (e.g., compared to execution times of different tasks) per gen speed. A number of gen speeds may be based on the communication interface. For example, responsive to the interface parameter value model 114 receiving telemetry values 212 from a GPU, a CPU, and a PCIe, the interface parameter can generate the relative execution times and performance values (not shown) per gen speed of the PCIe which can include gen speeds 1, 2, 3, 4, and 5. Based off of both the relative execution times and performance values (e.g., the model output 116), the interface parameter value selector 118 can select a gen speed (e.g., the interface parameter value 120). The interface parameter value selector 118 can apply an optimization function to the relative execution times and performance values to determine an optimal gen speed. The optimal gen speed may include a combination of highest performance value with lowest execution time. For example, as shown in FIG. 3, the interface parameter value selector 118 may compare the performance value of gen speeds 5, 4, and 3 since these gen speeds have equal execution times that are lower than gen speeds 2 and 1. The interface parameter value selector 118 may then choose, for example, the lowest gen speed with the highest performance value within gen speeds 1, 2, and 3.

The interface parameter value selector 118 can determine the power value 304 and, based on a mode of the computing device, allocate the power value 304 to various components of the computing device. The power value 304 can be a difference in a power expenditure value of the communication interface and/or the computing device prior to and following setting the communication interface to the interface parameter value 120. For example, the computing device can include a direct current (DC) mode and an alternating current (AC) mode. In some implementations, the DC mode is the battery mode and the AC mode is the core mode. Responsive to the computing device being set to the DC mode, the interface parameter value selector 118 can direct the power value 304 to the battery of the computing device for longer battery life. Responsive to the computing device being set to the AC mode, the interface parameter value selector 118 can direct the power value 304 to a core of the computing device for higher performance. The core can be the CPU (e.g., the second processing unit). The power value 304 can be allocated by the power manager 110.

In some implementations, the interface parameter value selector 118 can include logic to prevent the interface parameter value selector 118 from switching parameter values of the of the communication interface too frequently (e.g., frequency of parameter value switches leads to performance value drops). The interface parameter value selector 118 can include features to decrease a speed (e.g., frequency) of parameter value switching. The interface parameter value selector 118 can also include a time threshold. The time threshold may be indicative of a time between parameter value switching. For example, responsive to satisfying the time threshold, the interface parameter value model 114 generates the plurality of performance values and execution times based on the telemetry values and the interface parameter value selector 118 selects the interface parameter value 120 to set the communication interface to.

In some implementations, the computing device includes additional modes. For example, the computing device can include a graphics mode, a memory mode, and/or a cooling mode. Responsive to the computing device being set to the graphic mode, the power manager 110 can allocate the power value to the GPU for enhanced graphical performance. Responsive to the computing device being set to the memory mode, the power manager 110 can allocate the power value to a RAM for enhanced memory performance such as faster data access. Responsive to the computing device being set to the cooling mode, the power manager 110 can allocate the power value to a cooling system for better thermal management. In some implementations, the system 100 changes the mode of the computing device based on the plurality of first telemetry values 106 and the plurality of second telemetry values 108. In some implementations, a user manually adjusts the mode.

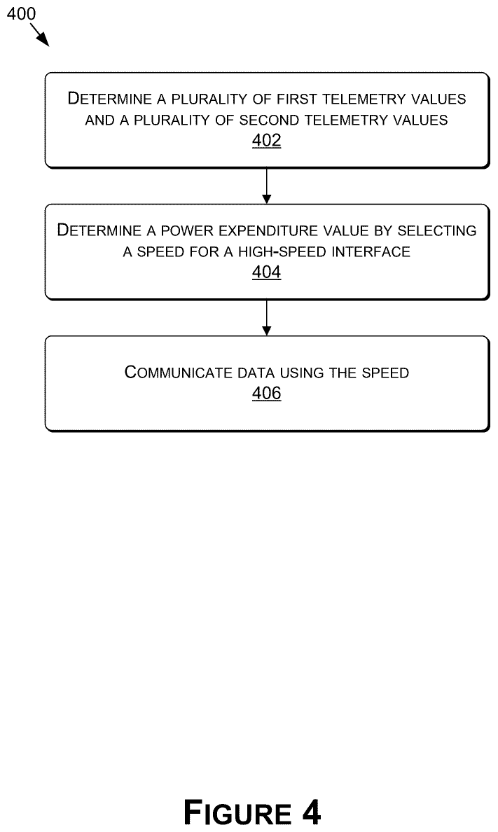

Now referring to FIG. 4, each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1, FIG. 2, and/or FIG. 3. However, this method may additionally or alternatively be executed by any one system, or any combination of systems, including, but not limited to, those described herein.

FIG. 4 is a flow diagram showing a method 400 for selecting a speed and communicating data using the speed in accordance with some implementations of the present disclosure. The method 400, at block 402, includes determining multiple telemetry values such as a plurality of first telemetry values (e.g., the plurality of first telemetry values 106) and a plurality of second telemetry values (e.g., the plurality of second telemetry values 108). The plurality of first telemetry values can be from a GPU (e.g., GPU 708). The plurality of second telemetry values can be from a CPU (e.g., CPU 706). The plurality of first telemetry values and the plurality of second telemetry values can be indicative of a workload of a computing device (e.g., computing device 700).

At block 404, a power expenditure value of a high-speed interface (e.g., communication interface 710) coupled to the GPU and the CPU is determined by selecting a speed (e.g., the interface parameter value 120) for the high-speed interface. The speed can be selected using a neural network (e.g., the interface parameter value model 114). The neural network can use at least a portion of the multiple telemetry portions (e.g., the plurality of first telemetry values, the plurality of second telemetry values, etc.) to select the speed.

At block 406, the high-speed interface can communicate data using the speed. For example, the communication interface is configured to use the speed.

In some implementations, the method 400 can also include receiving a mode of the computing device. A power value (e.g., power value 304) can also be determined. The power value can be indicative of a difference between the power expenditure value prior to and following communication of data using the speed on the high-speed interface. Based on the power value, the method 400 can include allocating the power value to one or more components of the computing device based on the mode. The mode can include at least one of a battery mode or a core mode. The battery mode can be indicative of allocating the power value to a battery to prolong a life of the computing device, while the core mode is indicative of allocating the power value to a core to improve a performance of the computing device.

In some implementations, to determine the speed, the neural network determines a plurality of execution times and a plurality of performance values (e.g., the model output 116) for a plurality of speeds of the high-speed interface. The plurality of execution times can be indicative of a data transfer rate of the high-speed interface and the plurality of performance values can be indicative of a performance of the high-speed interface. The high-speed interface can include a peripheral component interconnect express (PCIe). The neural network can be updated (e.g., trained) on a training dataset (e.g., the training dataset 202). The training dataset can include a plurality of training telemetry values (e.g., the training telemetry values 204) corresponding to a plurality of training execution times (e.g., the training execution times 206) and a plurality of training performance values (e.g., the training performance values 208).

In some implementations, the multiple telemetry values can include utilization of the GPU and the CPU, a clock speed of the GPU and the CPU, a rate of instruction execution by the GPU and the CPU, a bus arbitration (BA) signal, and performance readings of the GPU and the CPU.

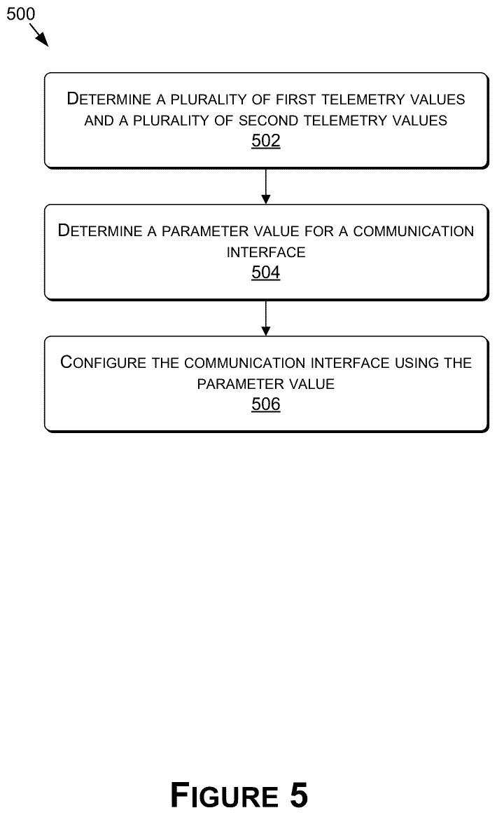

Now referring to FIG. 5, each block of method 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIG. 1, FIG. 2, and/or FIG. 3. However, this method may additionally or alternatively be executed by any one system, or any combination of systems, including, but not limited to, those described herein.

FIG. 5 is a flow diagram showing a method 500 for selecting a parameter value and communicating data using the parameter value in accordance with some implementations of the present disclosure. The method 500, at block 502 includes determining at least a plurality of first telemetry values (e.g., the plurality of first telemetry values 106) from a first processing unit and a plurality of second telemetry values (e.g., the plurality of second telemetry values 108) from a second processing unit, the plurality of first telemetry values and the plurality of second telemetry values indicative of a workload of a computing device. The first processing unit can be a GPU while the second processing unit can be a CPU.

At block 504, the method 500 includes determining, using a neural network, a parameter value for a parameter of a communication interface coupled to the first processing unit and the second processing unit based at least on the plurality of first telemetry values and the plurality of second telemetry values. The parameter value can be indicative of a bandwidth of the communication interface. The parameter can be at least one of a link bandwidth capacity scaling, power state entry threshold, operating frequency, power mode, power cap, latency tolerance, or credit throttling of the communication interface. The neural network can be executed on a hardware co-processor (e.g., the DL co-processor 112).

At block 506, the communication interface can be configured using the parameter value. For example, the communication interface can be communicatively coupled to the neural network, and communicate data based on the parameter value.

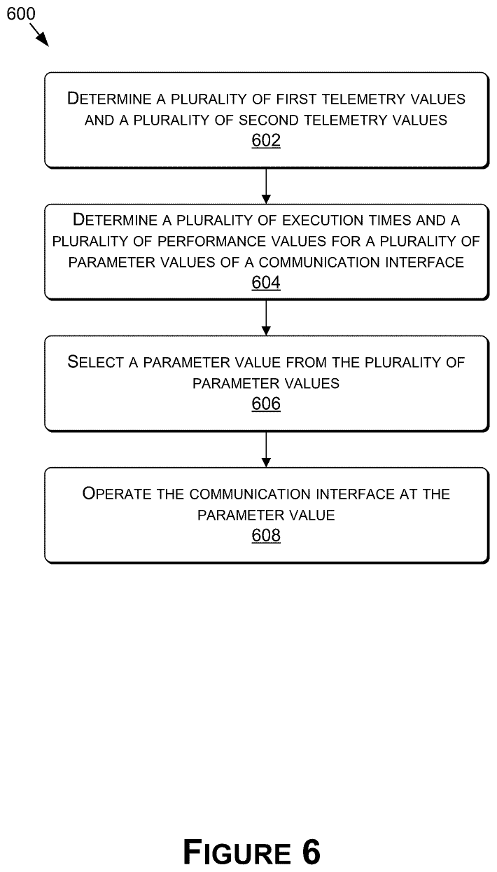

Now referring to FIG. 6, each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the system of FIG. 1, FIG. 2, and/or FIG. 3. However, this method may additionally or alternatively be executed by any one system, or any combination of systems, including, but not limited to, those described herein.

FIG. 6 is a flow diagram showing a method 600 for selecting a parameter value and communicating data using the parameter value in accordance with some implementations of the present disclosure. The method 600 at block 602 includes determining at least a plurality of first telemetry values (e.g., the plurality of first telemetry values 106) from a first processing unit and a plurality of second telemetry values (e.g., the plurality of second telemetry values 108) from a second processing unit, the plurality of first telemetry values and the plurality of second telemetry values indicative of a workload of a computing device.

At block 604, the method 600 includes determining, by a neural network (e.g., the interface parameter value model 114) a plurality of execution times and a plurality of performance values (e.g., the model output 116) for a plurality of parameter values of a communication interface coupled to the first processing unit and the second processing unit. The plurality of parameter values can be indicative of a bandwidth of the communication interface, the plurality of execution times can be indicative of a data transfer rate of the communication interface, and the plurality of performance values can be indicative of a performance of the communication interface.

At block 606, a parameter value from the parameter values is selected. The parameter value can be selected based on the plurality of execution times and the plurality of performance values. In some implementations, the parameter value can be selected by the interface parameter value selector 118.

At block 608, the communication interface can operate at the parameter value. In some implementations, the interface parameter value selector 118 can set the communication interface to the parameter value.

### Example Computing Device

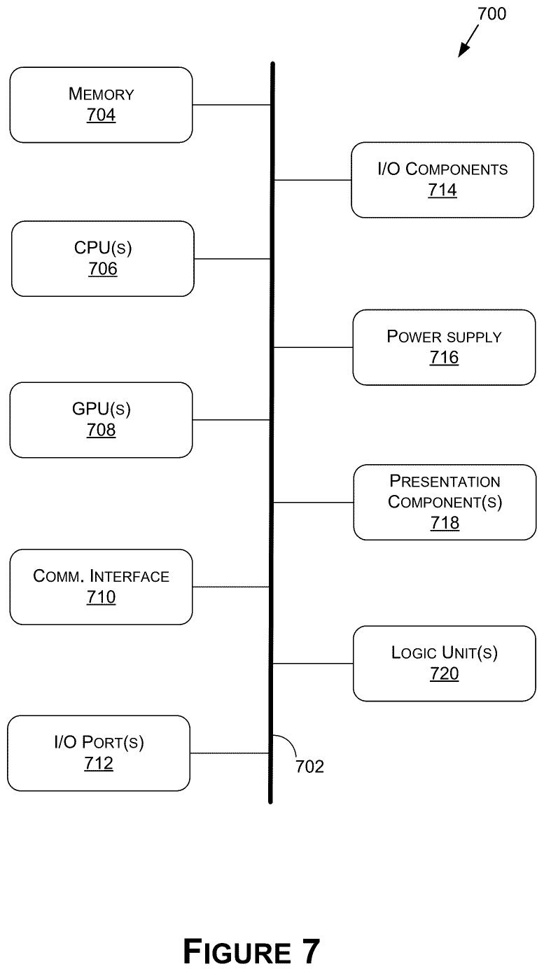

FIG. 7 is a block diagram of an example computing device(s) 700 suitable for use in implementing some implementations of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one implementation, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some implementations, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700. The plurality of first telemetry values 106 can be from a first side of the PCIe coupled to the GPU 708 and the plurality of second telemetry values 108 can be from a second side of the PCIe coupled to the CPU 706.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In implementations, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In implementations, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In implementations, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 720 and/or communication interface 710 may include one or more data processing units (DPUs) to transmit data received over a network and/or through interconnect system 702 directly to (e.g., a memory of) one or more GPU(s) 708. The system 100, the system 200, and/or the system 300 can be coupled to at least one of the communication interface 710, the GPU 708, or the CPU 706.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate. In the battery mode (e.g., the DC mode), the power manager 110 can allocate the power value 304 to the power supply 716.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

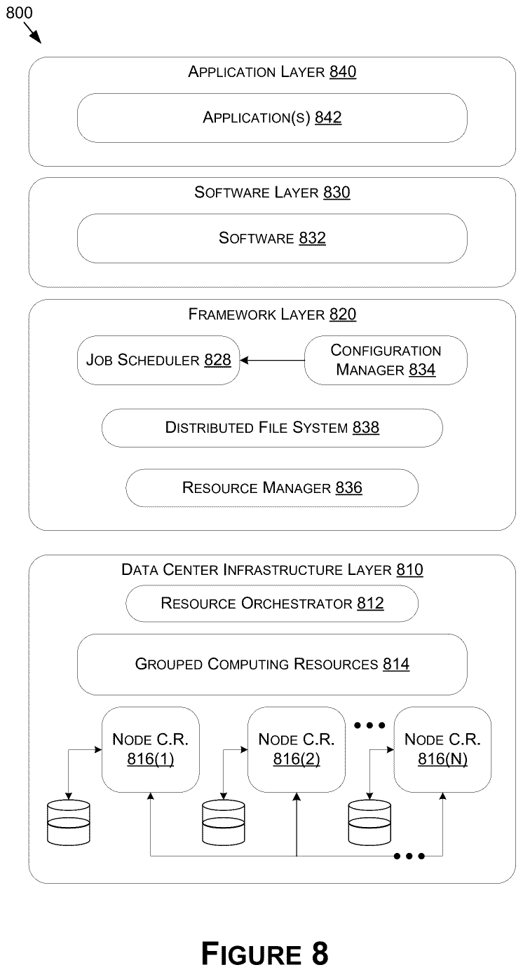

FIG. 8 illustrates an example data center 800 that may be used in at least one implementations of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one implementation, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 816(1)-816(N) may correspond to a server having one or more of the above-mentioned computing resources. In addition, in some implementations, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one implementation, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one implementation, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one implementation, resource orchestrator 812 may include a software design infrastructure (SDI) management entity for the data center 800. The resource orchestrator 812 may include hardware, software, or some combination thereof.

In at least one implementation, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one implementation, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one implementation, clustered or grouped computing resources may include grouped computing resource 814 at data center infrastructure layer 810. The resource manager 836 may coordinate with resource orchestrator 812 to manage these mapped or allocated computing resources.

In at least one implementation, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one implementation, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 800. In at least one implementation, trained or deployed machine learning models corresponding to one or more neural networks may be used to infer or predict information using resources described above with respect to the data center 800 by using weight parameters calculated through one or more training techniques, such as but not limited to those described herein. The data center 800 can train the interface parameter value model 114.

In at least one implementation, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system, comprising one or more processors to:
determine a plurality of first telemetry values from a graphics processing unit (GPU) and a plurality of second telemetry values from a central processing unit (CPU), the plurality of first telemetry values and the plurality of second telemetry values indicative of a workload of a computing device;
determine, based at least on the plurality of first telemetry values and the plurality of second telemetry values, a power expenditure value of a high-speed interface coupled to the GPU and the CPU by selecting, using a neural network, a speed for the high-speed interface; and
communicate, by the high-speed interface, data using the speed.

2. The system of claim 1, the one or more processors to:
receive a mode of the computing device;
determine a power value, the power value indicative of a difference between the power expenditure value prior to and following communication of data using the speed on the high-speed interface; and
allocate the power value to one or more components of the computing device based on the mode.

3. The system of claim 2, wherein the mode comprises a battery mode or a core mode, the battery mode indicative of allocating the power value to a battery to prolong a life of the computing device, the core mode indicative of allocating the power value to a core to improve a performance of the computing device.

4. The system of claim 1, wherein to determine the speed, the one or more processors to:
determine, by the neural network, a plurality of execution times and a plurality of performance values for a plurality of speeds of the high-speed interface, the plurality of execution times indicative of a data transfer rate of the high-speed interface and the plurality of performance values indicative of a performance of the high-speed interface; and
select, by the neural network, the speed from the plurality of speeds based on the plurality of execution times and the plurality of performance values.

5. The system of claim 1, wherein the high-speed interface comprises a peripheral component interconnect express (PCIe).

6. The system of claim 1, wherein the neural network is updated on a training dataset to select the speed prior to execution on the computing device, the training dataset comprising a plurality of training telemetry values corresponding to a plurality of training execution times and a plurality of training performance values.

7. The system of claim 1, wherein the plurality of first telemetry values and the plurality of second telemetry values comprise operating frequency, utilization, analog measurements, performance monitor counters, activity status, current operation status, and current low power mode status of at least one of the GPU, the CPU, or the high-speed interface.

8. The system of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing small language models (SLMs);
a system implementing multi-modal language models;
a system for hosting one or more real-time streaming applications;
a system for performing light transport simulation;
a system for performing collaborative content creation for 3D assets; or
a system implemented at least partially using cloud computing resources.

9. A system, comprising one or more processors to:
determine a plurality of first telemetry values from a first processing unit and a plurality of second telemetry values from a second processing unit, the plurality of first telemetry values and the plurality of second telemetry values indicative of a workload of a computing device;
determine, using a neural network, a parameter value for a parameter of a communication interface coupled to the first processing unit and the second processing unit based at least on the plurality of first telemetry values and the plurality of second telemetry values, the parameter value indicative of a bandwidth of the communication interface; and
configure the communication interface using the parameter value.

10. The system of claim 9, wherein the parameter is at least one of a link bandwidth capacity scaling, power state entry threshold, operating frequency, power mode, power cap, latency tolerance, or credit throttling of the communication interface.

11. The system of claim 9, wherein the plurality of first telemetry values and the plurality of second telemetry values comprise operating frequency, utilization, analog measurements, performance monitor counters, activity status, current operation status, and current low power mode status of at least one of the first processing unit, the second processing unit, or the communication interface.

12. The system of claim 9, the one or more processors to:
receive a mode of the computing device;
determine a power value, the power value indicative of a difference between a bandwidth value prior to and following communication of data using the parameter value on the communication interface; and
allocate the power value to one or more components of the computing device based on the mode.

13. The system of claim 12, wherein the mode comprises a battery mode or a core mode, the battery mode indicative of allocating the power value to a battery to prolong a life of the computing device, the core mode indicative of allocating the power value to a core to improve a performance of the computing device.

14. The system of claim 9, wherein to determine the parameter value, the one or more processors to:
determine, by the neural network, a plurality of execution times and a plurality of performance values for a plurality of parameter values of the communication interface, the plurality of execution times indicative of a data transfer rate of the communication interface and the plurality of performance values indicative of a performance of the communication interface; and
select, by the neural network, the parameter value from the plurality of parameter values based on the plurality of execution times and the plurality of performance values.

15. The system of claim 9, wherein the first processing unit is a graphics processing unit (GPU) and the second processing unit is a central processing unit (CPU).

16. The system of claim 9, wherein the neural network is updated on a training dataset to select the parameter value prior to execution on the computing device, the training dataset comprising a plurality of training telemetry values corresponding to a plurality of training execution times and a plurality of training performance values.

17. The system of claim 9, wherein the neural network is executed on a hardware co-processor.

18. The system of claim 9, wherein the communication interface comprises a high-speed communication interface.

19. A method comprising:
determining a plurality of first telemetry values from a first processing unit and a plurality of second telemetry values from a second processing unit, the plurality of first telemetry values and the plurality of second telemetry values indicative of a workload of a computing device;
determining, by a neural network, a plurality of execution times and a plurality of performance values for a plurality of parameter values of a communication interface coupled to the first processing unit and the second processing unit, the plurality of parameter values indicative of a bandwidth of the communication interface, the plurality of execution times indicative of a data transfer rate of the communication interface, and the plurality of performance values indicative of a performance of the communication interface;
selecting a parameter value from the plurality of parameter values based on the plurality of execution times and the plurality of performance values; and
operating the communication interface at the parameter value.

20. The method of claim 19, wherein the neural network is updated on a training dataset to select the parameter value prior to execution on the computing device, the training dataset comprising a plurality of training telemetry values corresponding to a plurality of training execution times and a plurality of training performance values.
